(19) United States
(12) Patent Application Publication
(10) Pub. No.: US 2025/0073722 A1
(43) Pub. Date: Mar. 6, 2025

(54) RECEPTACLE FOR CONTAINERS AND CONTAINER ARRANGEMENTS, AND RECEPTACLE ARRANGEMENT FOR CONTAINERS

(71) Applicant: TECAN GENOMICS, INC., Redwood City, CA (US)

(72) Inventors: Jonathan Patrick CASEY, Cambridge (GB); Thomas William BROUGHTON, Hitchin Hitchin (GB); Adrian SAGER, Männedorf (CH)

(21) Appl. No.: 18/722,320

(22) PCT Filed: Dec. 29, 2021
(86) PCT No.: PCT/US2021/065442

§ 371 Date: Jun. 20, 2024

(51) Int. Cl. B01L 3/00

(52) U.S. Cl. CPC B01L 3/50853; B01L 2200/025; B01L 2300/044; B01L 2300/0829

(57) ABSTRACT

A receptacle for containers has a rigid frame with a frame plate with a closed periphery and several recesses for receiving the containers. The frame has a closed circumferential collar extending from the periphery of the frame plate. The receptacle has a rigid cover that is fixed to the frame. The cover has a cover plate with a closed periphery with several through holes that are aligned with the recesses of the frame. The cover also has a closed circumferential collar extending from the periphery of the cover plate fitting the frame collar. A free space is provided between the frame plate and the cover plate in which the containers can be arranged so that each container is accessible from the outside.

### TECHNICAL FIELD OF THE INVENTION

The current invention relates to receptacles for containers and container arrangements, in particular to receptacles for laboratory containers and laboratory container arrangements for liquid to be dispensed into other laboratory containers, preferably in a single shot.

### DESCRIPTION OF THE RELATED ART

US 2019/0120868 discloses a receptacle wherein a blister layer can be arranged on a frame that is an integral part of a reagent delivery apparatus. Such a design has the disadvantage that errors can be made during the placement of the blister layer, which then lead to undesirable consequential process errors. To avoid errors, the placement must be carried out with appropriate care, which is time-consuming and requires appropriately trained users.

### SUMMARY OF THE INVENTION

It is a task of the current invention to provide a receptacle for containers and container arrangements for liquids to be dispensed into other containers, preferably in a single shot, while avoiding the disadvantages of the previously mentioned related art.

This task is solved by a receptacle with the features of claim 1. Further embodiments of receptacles and of receptacle arrangements are defined by the features of further claims.

A receptacle for containers for liquid to be dispensed according to the invention comprises a rigid frame with a frame plate extending in a longitudinal direction and in a transverse direction. The frame plate has a closed periphery and has several recesses for receiving said containers from a receiving side. The frame further has an essentially closed circumferential collar extending from a peripheral region of the frame plate towards the receiving side. The frame collar needs not to be completely closed, but the fewer the breakouts, the greater the stability of the frame. The receptacle further comprises a rigid cover that is fixed to the frame. The cover has a cover plate with a closed periphery and with several through holes that are aligned with the recesses of the frame. The cover further has an essentially closed circumferential collar extending from a peripheral region of the cover plate towards the frame plate, wherein the cover collar complementary fits the frame collar. Also, the cover collar needs not to be completely closed, but it is advantageous for the stability of the cover. A free space is provided between the frame plate and the cover plate, in which free space, said containers can be arranged in a fitted manner as such that each container is accessible from the outside through the corresponding recess of the frame and the corresponding through hole of the cover.

With such a design, the containers are precisely arranged in a rigid receptacle, such as a cartridge formed by the frame and the cover, which cartridge can then be used for a precise arrangement within a device, thus reducing the alignment errors that can be made by a user due to improper operation. Thus, enabling an exact dispensing of liquids into other containers. The dispensing can be executed in a single shot or in multiple shots.

In one embodiment, the fixation of the cover to the frame is permanent. Permanent fixations can be realized for example by welding, such as thermal welding or ultrasonic welding, gluing, or non-removable interlocking elements. Alternatively, the fixation can be reversible, which can be realized for example by removable interlocking elements, such as removable latching, catch arrangement or by screwing.

In one embodiment, the recesses of the frame are slots that extend from a first lateral side of the frame to a second lateral side of the frame, opposite the first lateral side and wherein two neighbouring slots are separated from one another by transverse webs. Alternatively, the recesses can be single holes, that are separated from one another by transverse webs and longitudinal webs.

In one embodiment, all recesses of the frame are identical, and are separated from one another by first transverse webs or by second transverse webs. All through holes of the cover are identical and are separated from one another by first transverse webs and longitudinal webs or by second transverse webs and longitudinal webs. For example, the second transverse webs are wider than the first transverse webs. However, the first or second transverse webs of the frame have essentially the same width as the ones of the cover.

In one embodiment, connectors are arranged adjacent to the recesses of the frame that extend from the frame plate towards the cover. The crossings of the first and second transverse webs of the cover and the longitudinal webs of the cover are connected to the connectors of the frame.

In one embodiment, first positioning holes are provided in the frame plate that are aligned with the recesses of the frame on a first transverse side thereof and first centering holes are provided in the cover plate that are aligned with the respective first positioning holes of the frame. For example, the first positioning holes and the first centering holes are cylindrical through holes. The diameter of the centering holes can be identical or bigger than the diameter of the positioning holes.

In one embodiment, second positioning holes are provided in the frame plate that are aligned with the recesses of the frame on a second transverse side thereof, opposite to the first transverse side. Second centering holes are provided in the cover plate that are aligned with the respective second positioning holes of the frame. The second positioning holes and centering holes can be identical to the first positioning holes or centering holes, respectively. Alternatively, the second positioning holes and centering holes are slots, wherein the width of the slot can be identical to the diameter of the first positioning hole and wherein the length of the slot is bigger than the diameter of the first positioning hole. Alternatively, the width of the slot can be bigger than the diameter of the first positioning hole.

In one embodiment, collars are provided that extend from the frame plate towards the cover at the circumferences of the positioning holes, forming a sleeve. Additionally, or alternatively, collars are provided that extend from the cover plate towards the frame at the circumferences of the centering holes, forming a sleeve. Additionally, collars can extend from the frame plate towards the side opposite the cover, and collars can extend from the cover plate towards the side opposite the frame.

In one embodiment, ribs are provided that extend from the frame plate towards the cover that connect the collars of the positioning holes to the closed circumferential collar of the frame plate. Additionally, or alternatively, ribs are provided that extend from the cover plate towards the frame that connect the collars of the centering holes to the closed circumferential collar of the cover plate.

In one embodiment, an offset is provided on a first longitudinal side of the frame that is offset from the frame plate in the direction of the cover, that is connected to the frame plate around at least a part of its circumference and that extends over at least a part of the first longitudinal side of the frame plate. Additionally, or alternatively, an offset is provided on a first longitudinal side of the cover that is offset from the cover plate in the direction of the frame, that is connected to the cover plate around at least a part of its circumference and that extends over at least a part of the first longitudinal side of the cover plate. The offset of the frame, alone or in combination with the offset of the cover, forms a handle for a thumb and at least one opposing finger. Ideally, the handle can be gripped by the thumb and four fingers.

In one embodiment, interlocking elements are provided in the circumferential collar of the frame. Alternatively, interlocking elements are provided in the circumferential collar of the frame and at the connectors of the frame. Accordingly, corresponding interlocking elements are provided in the circumferential collar of the cover or in the circumferential collar of the cover and at the crossings of the transverse webs of the cover and the longitudinal webs of the cover. The interlocking elements of the frame match the corresponding interlocking elements of the cover and are therefore complementary to one another.

In one embodiment, a fixation recess is provided in the circumferential collar of the frame. Additionally, or alternatively, a fixation recess is provided in the circumferential collar of the cover. The fixation recess of the frame is matching the fixation recess of the cover.

Since the cover collar is overlapping the frame collar, the cover fixation recess is overlapping the frame fixation recess. For example, the fixation recess is a clamping groove, in which a clamping element, such as a spring-loaded pin or ball can engage. The clamping element can be arranged on a movable carrier for the receptacle or a fixed pedestal for the receptacle.

The features of the above-mentioned embodiments of the receptacle can be used in any combination unless they contradict each other.

A receptacle arrangement according to the invention comprises a receptacle according one of the preceding embodiments and containers or container arrangements for liquid to be dispensed. The containers or container arrangements are received in the corresponding recesses of the frame and are arranged in the free space provided between the frame plate and the cover plate. For example, such container of container arrangements are blister strips or blister plates. A blister strip comprises several blisters arranged on a common line and a blister plate comprises several blister strips arranged parallel to each other. A blister strip comprises a rigid lower layer with a cavity and a flexible top layer that seals the cavity. The cavity can be filled with a liquid to be dispensed in a single shot. It is also possible to use blisters for dispensing liquid in several shots. For example, dispensing only a part of the liquid contained in a single blister or dispensing the content of several blisters in a single container. For the dispensing of said liquid, a nozzle is provided at the bottom of the cavity. Accordingly, a flexible top layer is accessible from the top via the corresponding through hole of the cover and the liquid can be dispensed at the bottom via the corresponding recess of the frame.

In one embodiment, first containers or container arrangements are provided, containing a first liquid to be dispensed. Alternatively, first containers or container arrangements are provided, containing a first liquid to be dispensed and second containers or container arrangements are provided, containing a second liquid to be dispensed. In one embodiment, a positioning frame is provided, wherein at least one receptacle according to one of the previous embodiments is received in a corresponding recess of the positioning frame. Such a design has the advantage that the positioning frame can be re-used whilst the receptacles to be received are single use only. A further advantage is that a receptacle with a specific arrangement of the received containers can be prepared by a skilled worker and the prepared receptacle can be inserted into the positioning frame by a non-skilled worker without the risk of an incorrect positioning of the containers.

In one embodiment, a label is arranged on the top surface of the cover plate 20. For example, the label is a printed or engraved 1D or 2D barcode or matrix code. Other optically readable labels, such as colors or electronically readable labels, such as RFID tags can also be used. With electronically readable labels, the label need not be on the top surface, but can be enclosed in the connecting plate. The label can comprise information regarding the amount, arrangement and content of the containers or container arrangements that are enclosed in the receptacle.

The features of the above-mentioned embodiments of the receptacle arrangement can be used in any combination unless they contradict each other.

A method for assembling a receptacle arrangement according to one of the before-mentioned embodiments comprising the steps of:
providing a frame according to one of the before-mentioned embodiments;
arranging at least one container or container arrangement in the recesses of the frame;
arranging the cover on the frame and thereby enclosing the at least one container or container arrangement between the frame and the cover;
fixing the cover to the frame.

In one embodiment, at least one tear-off film is fixed to the at least one container or container arrangement on parts thereof protruding the frame, after the at least one container or container arrangement have been arranged in the recesses of the frame. The protruding part comprises the bottom of a blister of a blister strip comprising a nozzle that is already sealed by a tear-off film. It is possible to use several tear-off films that are fixed to individual regions, or it is possible to use one single tear-off film for the entirety of the nozzles.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a perspective explosion view of a receptacle arrangement with a first embodiment of a receptacle according to the invention;

FIG. 2 a section view in a first plane of the receptacle arrangement of FIG. 1 in the assembled state;

FIG. 3 a section view in a second plane of the receptacle arrangement of FIG. 1 in the assembled state;

FIG. 4 a perspective explosion view of a second embodiment of a receptacle arrangement according to the invention; and

FIG. 5 a perspective explosion view of a third embodiment of a receptacle arrangement according to the invention.

### DETAILED DESCRIPTION OF THE INVENTION

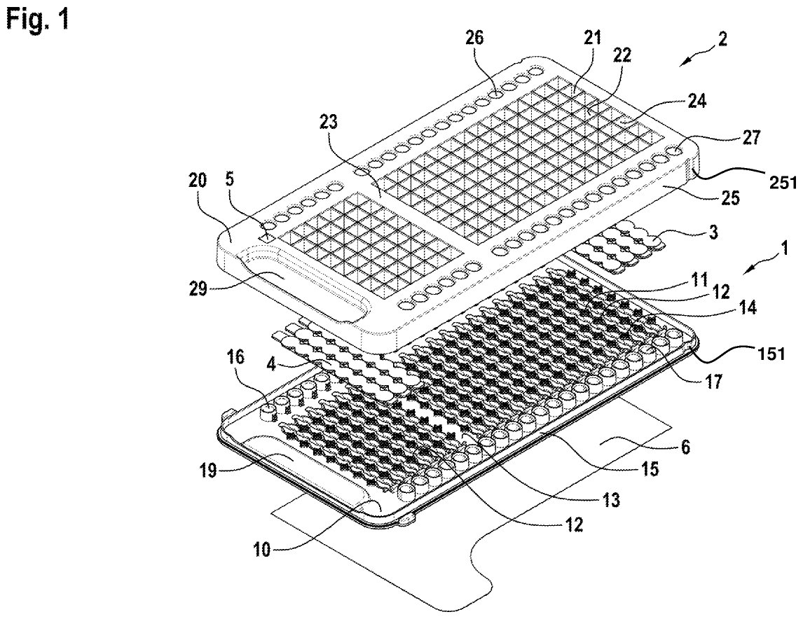

FIG. 1 shows a perspective explosion view of a receptacle arrangement with a first embodiment of a receptacle according to the invention. The shown receptacle comprises a rigid frame 1 and a rigid cover 2, between which a first container arrangement 3 and a second container arrangement 4 are arranged. A label 5 is arranged on the top surface of the cover 2. The frame 1 comprises a frame plate 10 extending in a longitudinal direction and in a transverse direction, perpendicular to the longitudinal direction. The frame plate 10 having a closed periphery and having several recesses 11 for receiving container arrangements 3,4 from a receiving top side.

The recesses 11 are slots that extend in the transverse direction over a substantial range of the frame plate 10.

The recesses 11 are designed to receive container arrangement in the form of blister plates 3,4, wherein each blister plate comprises several blister strips that are arranged parallels to each other. Each blister strip comprises eight blisters aligned on a common line and connected to one another. Thus, the slots 11 have a length that is essentially eight times its width. However, the same principle is applicable for any number of blisters per strip, or per plate respectively. Each blister strip has a lower rigid layer with a cavity with a nozzle at its bottom and an upper flexible layer which seals the cavity at the top. Each nozzle separately or all nozzles of a blister strip are covered by a tear-off film.

Two adjoining slots 11 for blister strips of a common blister plate 3,4 are separated from one another by first traverse webs 12 and two adjoining slots 11 for blister strips of the first blister plate 3 and for blister strips of the second blister plate 4 are separated from one another by a second traverse web 13. The second traverse web 13 is wider than the first traverse webs, for example, twice as wide. Since it is important to keep a predefined pitch between adjoining blister strips, the width of the second traverse web 13 corresponds to the width of a single blister strip. In the shown embodiment, the pith between two adjoining blister strips corresponds to the pitch between two adjoining blisters on a common strip and is 9 millimeters.

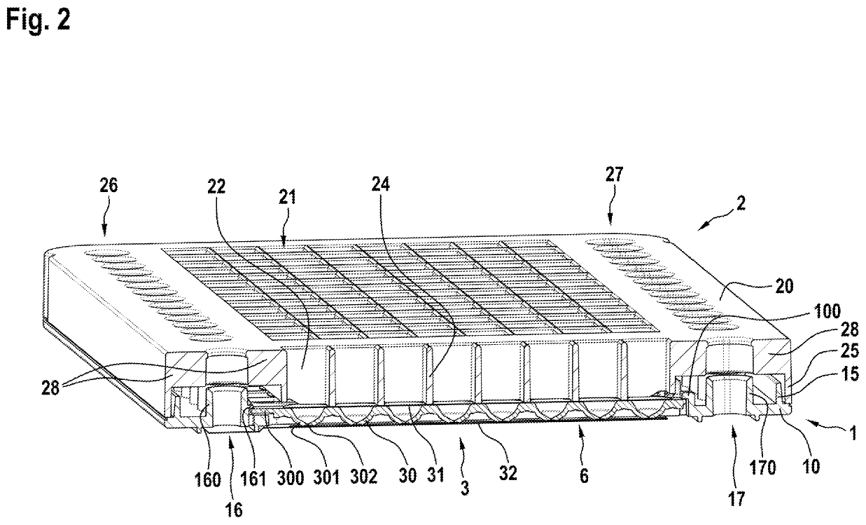

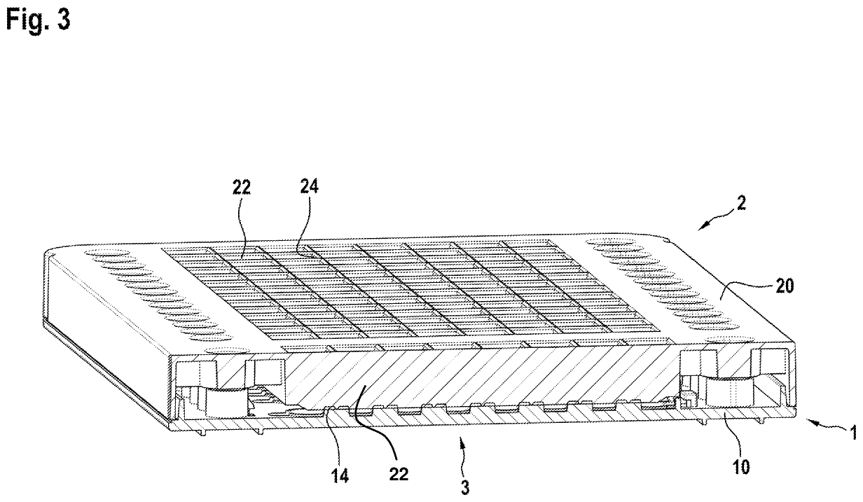

FIG. 2 shows a section view in a first plane through a line of recesses 11 of the receptacle arrangement of FIG. 1 in the assembled state and FIG. 3 shows a section view in a second plane through a first traverse web 12 of the receptacle arrangement of FIG. 1 in the assembled state.

The shown container arrangement 3 is a blister plate comprising several blister strips. Each blister strip comprises a rigid bottom layer 30 with eight blisters 301 that are connected to each other by a common connection plate 300. A nozzle 302 is located at the bottom of each blister 301. The blisters 301 of a blister strip are sealed at their top with a common flexible top layer 31 and the nozzles 302 of a blister strip are sealed at their bottom with a common first tear-off film 32. A second tear-off film 6 is attached to the first tear-off film 32 of several blister strips.

On the middle line of each first traverse web 12, between two blisters of each of two adjoining blister strips, connectors 14 are provided that extend from the frame plate 10 upwards towards the cover 2. The connectors 14 are cross-shaped and have a height that is a fraction of the thickness of the frame plate 10. In the shown embodiment, the frame plate 10 has a thickness of about 2 millimeters and the connectors 14 have a height of about 2 millimeters.

The frame 1 further having an essentially closed circumferential collar 15 extending from a peripheral region of the frame plate 10 towards the cover 2. The height of the collar 15 is a multiple of the thickness of the frame plate 10. In the shown embodiment, the height of the frame collar 15 is about 4 millimeters.

First positioning holes 16 are provided in the frame plate 10 that are aligned with the recesses 11 of the frame 1 on a first transverse side thereof and second positioning holes 17 are provided in the frame plate 10 that are aligned with the recesses 11 of the frame 1 on a second transverse side thereof, opposite the first side. The first positioning holes 16 are designed as cylindrical bores and the second positioning holes 17 are designed as slots that extend in the extension of the recesses 11. The width of the second positioning holes 17 is identical to the diameter of the first positioning holes 16 and the length of the second positioning holes 17 is slightly bigger.

Collars 160,170 extend from the frame plate 10 towards the cover 2 at the circumferences of the positioning holes 16, 17. The height of these collars is a multiple of the thickness of the frame plate 10. In the shown embodiment, the height of the positioning hole collars 160, 170 is about 5 millimeters.

Adjacent to the second positioning hole collars 170 facing the blister strip arrangements 3, 4, first retainers 100 are provided. On the lateral sides of the first positioning hole collars 160 facing the container arrangements 3,4, second retainers 161 are provided. In the assembled state, a first end of the connecting plate 300 of the rigid bottom layer 30 of each blister strip is held between the frame plate 10 and the corresponding first retainer 100 and an opposite second end of the blister strip is held between the frame plate 10 and the corresponding second retainer 161.

An offset 19 is provided on a first longitudinal side of the frame 1 that is offset from the frame plate 10 in the direction of the cover 2. The offset 19 is connected to the frame plate 10 around an inward directed part of its circumference. The offset 19 extends over a substantial part of the length the first longitudinal side of the frame plate 10. The offset 19 serves as handle for human fingers. Two fixation recesses 151 are provided in the frame collar 15 on both transverse sides in an end region of the frame 1 on a second longitudinal side, opposite the offset 19.

The cover 2 comprises a cover plate 20 with a closed periphery and with several through holes 21 that are aligned with the recesses 11 of the frame 1.

The through holes 21 are defined on the outside by the closed periphery and internally by first and second traverse webs 22, 23 and by longitudinal webs 24.

The first traverse webs 22 of the cover 2 are aligned with the first traverse webs 12 of the frame 1 and the second traverse web 23 is aligned with the second traverse web 13 of the frame 1. The first and second traverse webs 22, 23 as well as the longitudinal webs 24 extend almost over the entire height of the cover 2. It is also possible that these webs extend only over a part of the height of the cover. Each longitudinal web 24 separates two adjoining blisters of a common blister strip. Each blister is arranged concentrically to the corresponding through hole 21 of the cover 2.

The cover 2 further having an essentially closed circumferential collar 25 extending from a peripheral region of the cover plate 20 towards the frame plate 10.

The cover collar 25 complementary fits the frame collar 15, i.e., the cover collar 25 overlaps the frame collar 15. The height of the cover collar 25 is a multiple of the thickness of the cover plate 2. In the shown embodiment, the height of the cover collar 25 is about 12 millimeters.

First centering holes 26 are provided in the cover plate 20 that are aligned with the respective first positioning holes 16 of the frame 1 and second centering holes 27 are provided in the cover plate 20 that are aligned with the respective second positioning holes 17 of the frame 1. The first centering holes 26 are designed as cylindrical bores and the second centering holes 27 are designed as slots that extend in the extension of the through holes 21. The outside dimensions of the positioning holes 16,17 are smaller than the outside dimensions of the centering holes 26, 27, i.e., the diameter and slot length of the positioning holes 16,17 are smaller than those of the centering holes 26,27.

Collars 260,270 extend from the cover plate 20 towards the frame 1 at the circumferences of the centering holes 26,27.

The height of these collars is a multiple of the thickness of the cover plate 20. In the shown embodiment, the height of the centering hole collars 260, 270 is about 6 millimeters.

Ribs 28 extend from the cover plate 20 towards the frame 1 and connect the collars 260, 270 of the positioning bores 26, 27 to the cover plate 20 on an inward facing side of the collars 260, 270 and to the cover plate and to the circumferential cover collar 25 on an outward facing side of the collars 260, 270.

An offset 29 is provided on a first longitudinal side of the cover 2 that is offset from the cover plate 20 in the direction of the frame 1. The offset 29 is connected to the cover plate 20 around an inward directed part of its circumference. The width and depth of the offset 29 of the cover 2 are identical to those of the offset 19 of the frame 1.

Two fixation recesses 251 are provided in the cover collar 25 on both transverse sides and are overlapping the fixation recesses 151 of the frame collar 15.

When assembling the embodiment of the receptacle arrangement shown in FIGS. 1 to 3, the blister strips or blister plates 3,4 are inserted into the designated recesses 11 of the frame 1. Subsequently, the cover 2 is arranged on top of the frame 1, resulting in an exact fixation of the blister plates 3,4 between the frame 1 and the cover 2. Subsequently, the cover 2 is fixed to the frame 1, for example by ultrasonic welding. The fixing takes place in the contact regions of the connectors 14 of the frame 1 and the crossing points of the traverse and longitudinal webs 22, 23,24 of the cover 2. Additionally, the cover 2 can be fixed to the frame 1 with its circumferential collar 25, at least partially. There can be several fixing points that are distributed around the circumference of the cover collar 25. This embodiment of receptacle arrangement cannot be disassembled without destroying at least parts of the frame 1 and/or parts of the cover 2.

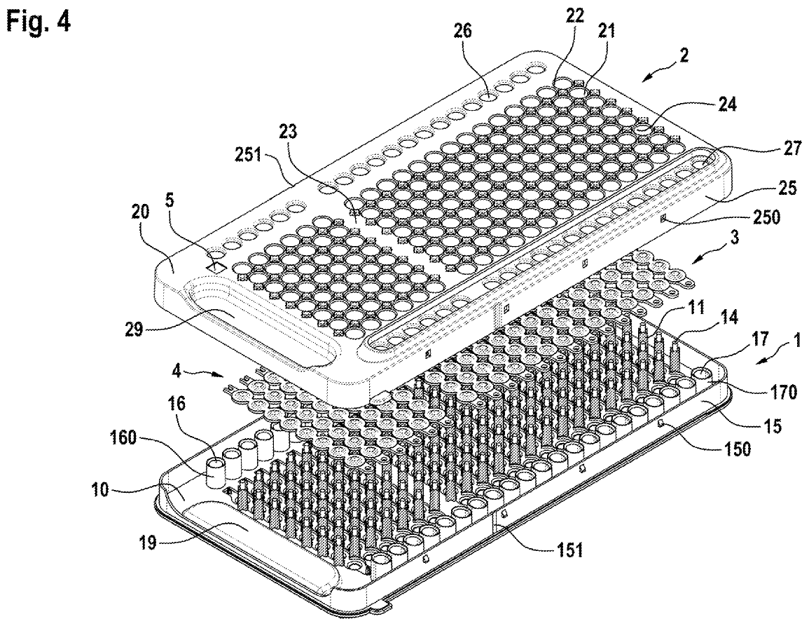

FIG. 4 shows a perspective explosion view of a second embodiment of a receptacle arrangement according to the invention. Similar or identical features of this embodiment are designated with the same reference signs as the ones from the previous embodiment. In the following, mainly the differences to the first embodiment are stated. Features not mentioned are considered identical or equivalent. The recesses 11 of the frame 1 are not slots, but individual holes that are arranged on lines that extend from a first lateral side of the frame 1 to a second lateral side of the frame 1, opposite the first lateral side.

Consequently, the first traverse webs 12 among themselves and the first traverse webs 12 and the second traverse web 13 are not completely separated from each other but are connected to each other in between two adjoining holes 11. The connectors 14 are arranged in the same locations as in the first embodiment but they are pin-shaped their height is a multiple of the thickness of the frame plate 10. In the shown embodiment, the connectors 14 have a height of about 12 millimeters.

The circumferential collar 15 extends from the frame plate 10 to the same height as the connectors 14 or a bit less.

Several interlocking elements 150 are distributed around the circumference of the circumferential frame collar 15. The shown interlocking elements are notches that extend laterally over the outer surface of the circumferential frame collar 15.

The fixation recess 151 is aligned with the second traverse web 13 of the frame 1.

The collars 160, 170 at the circumferences of the positioning holes 16,17 extend to the same height as the circumferential frame collar 15.

The through holes 21 of the cover 2 are designed as cylindrical through bores.

The traverse webs 22, 23 and the longitudinal webs 24 of the cover have essentially the same thickness as the cover plate 20.

Several interlocking elements 250 are distributed around the circumference of the circumferential cover collar 25. The shown interlocking elements are cut outs that are complementary the notches of the frame 1.

The fixation recess 251 is aligned with the second traverse web 23 of the cover 2.

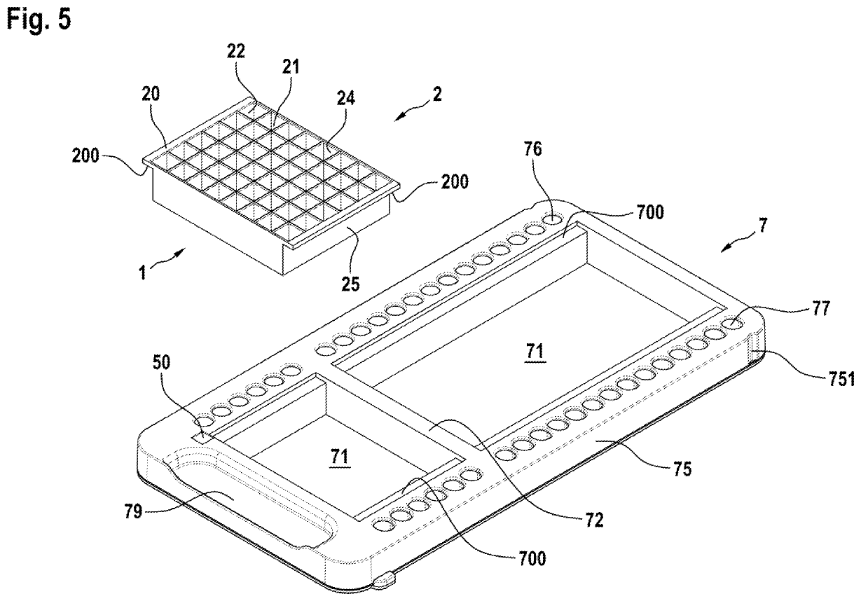

FIG. 5 shows a perspective explosion view of a third embodiment of a receptacle arrangement according to the invention. Similar or identical features of this embodiment are designated with the same reference signs as the ones from the previous two embodiments. In the following, mainly the differences to the first and second embodiment are stated. Features not mentioned are considered identical or equivalent.

The frame 1 together with the cover 2 are designed as an insert that can be arranged in a recess 71 of a positioning frame 7. The cover plate 20 extends laterally over the circumferential cover collar 25 and forms flaps 200 on each side of the cover 2. In the assembled state, these flaps 200 can rest on corresponding receptions 700 of the positioning frame recess 71.

The first and second positioning holes 76, 77 are formed in the positioning frame 7 and are aligned with the through holes 21 of the cover 2 in the assembled state.

The fixation recesses 751 are formed on both lateral sides of the positioning frame 7 in the corresponding lateral side faces 75.

A label 50 is provided at the top surface of the positioning frame 7.

REFERENCE SIGNS LIST

| | | | |
|---|---|---|---|
| 1 | frame | 22 | first traverse web |
| 10 | frame plate | 23 | second traverse web |
| 100 | first retainer | 24 | longitudinal web |
| 11 | recess | 25 | collar |
| 12 | first traverse web | 250 | interlocking element |
| 13 | second traverse web | 251 | fixation recess |
| 14 | connectors | 26 | first centering hole |
| 15 | collar | 27 | second centering hole |
| 150 | interlocking element | 28 | rib |
| 151 | fixation recess | 29 | offset |
| 16 | first positioning hole | 3 | first container arrangement |
| 160 | collar | 30 | rigid bottom layer |
| 161 | second retainer | 300 | connection plate |
| 17 | second positioning hole | 301 | blister |
| 170 | collar | 302 | nozzle |
| 19 | offset | 31 | flexible top layer |
| 2 | cover | 32 | first tear-off film |
| 20 | cover plate | 4 | second container arrangement |
| 200 | flap | 72 | traverse web |
| 21 | through hole | 75 | lateral side face |
| 5 | label | 751 | fixation recess |
| 50 | label | 76 | first positioning hole |
| 6 | second tear-off film | 77 | second positioning hole |
| 7 | positioning frame | 79 | offset |
| 700 | reception | | |
| 71 | recess | | |

1. A receptacle for containers (3;4) for liquid to be dispensed comprising:
a rigid frame (1) with a frame plate (10) extending in a longitudinal direction and in a transverse direction, the frame plate (10) having a closed periphery and having several recesses (11) for receiving said containers (3;4) from a receiving side,
the rigid frame (1) further having an essentially closed circumferential collar (15) extending from a peripheral region of the frame plate (10) towards the receiving side,
a rigid cover (2) that is fixed to the frame (1), the rigid cover (2) having a cover plate (20) with a closed periphery and with several through holes (21) that are aligned with the recesses (11) of the frame (1), the rigid cover (2) further having an essentially closed circumferential collar (25) extending from a peripheral region of the cover plate (20) towards the frame plate (10), and
wherein the cover collar (25) complementary fits the frame collar (15), and wherein a free space is provided between the frame plate (10) and the cover plate (20) in which said containers (3;4) can be arranged in a fitted manner as such that each container (3;4) is accessible from the outside through the corresponding recess (11) of the frame (1) and the corresponding through hole (21) of the cover (2).

2. The receptacle according to claim 1, wherein the fixation of the cover (2) to the frame (1) is permanent.

3. The receptacle according to claim 1, wherein the recesses (11) of the frame (1) are slots that extend from a first lateral side of the frame (1) to a second lateral side of the frame (1), opposite the first lateral side and wherein two neighbouring slots (11) are separated from one another by transverse webs (12;13).

4. The receptacle according to claim 1, wherein all recesses (11) of the frame (1) are identical and wherein the recesses (11) of the frame (1) are separated from one another by first transverse webs (12) or by second transverse webs (13) and wherein all through holes (21) of the cover (2) are identical and wherein the through holes (21) of the cover (2) are separated from one another by first transverse webs (22) and longitudinal webs (24) or by second transverse webs (23) and longitudinal webs (24).

5. The receptacle according to claim 1, wherein connectors (14) are arranged adjacent to the recesses (11) of the frame (1) that extend from the frame plate (10) towards the cover (2) and wherein the crossings of the transverse webs (22;23) of the cover (2) and the longitudinal webs (24) of the cover (2) are connected to the connectors (14) of the frame (1).

6. The receptacle according to claim 1, wherein first positioning holes (16) are provided in the frame plate (10) that are aligned with the recesses (11) of the frame (1) on a first transverse side thereof and wherein first centering holes (26) are provided in the cover plate (20) that are aligned with the respective first positioning holes (16) of the frame (1).

7. The receptacle according to claim 1, wherein second positioning holes (17) are provided in the frame plate (10) that are aligned with the recesses (11) of the frame (1) on a second transverse side thereof and wherein second centering holes (27) are provided in the cover plate (20) that are aligned with the respective second positioning holes (17) of the frame (1).

8. The receptacle according to claim 6, wherein collars (160;170) are provided that extend from the frame plate (10) towards the cover (2) at the circumferences of the positioning holes (16;17) and/or wherein collars (260;270) are provided that extend from the cover plate (20) towards the frame (1) at the circumferences of the centering holes (26;27).

9. The receptacle according to claim 8, wherein ribs (18) are provided that extend from the frame plate (10) towards the cover (2) and that connect the collars (160;170) of the positioning holes (16;17) to the closed circumferential collar (15) of the frame plate (10) and/or wherein ribs (28) are provided that extend from the cover plate (20) towards the frame (1) and that connect the collars (260; 270) of the centering holes (26;27) to the closed circumferential collar (25) of the cover plate (20).

10. The receptacle according to one of the preceding claims, wherein interlocking elements (150) are provided in the circumferential collar (15) of the frame (1), and wherein interlocking elements (250) are provided in the circumferential collar (25) of the cover (2), and wherein the interlocking elements (150) of the frame (1) match the corresponding interlocking elements (250) of the cover (2).

11. A receptacle arrangement comprising a receptacle according to claim 1 and containers or container arrangements (3;4) for liquid to be dispensed, wherein the containers or container arrangements (3;4) are received in the corresponding recesses (11) of the frame (1) and are arranged in the free space provided between the frame plate (10) and the cover plate (20).

12. The receptacle arrangement according to claim 11, wherein first containers or container arrangements (3) are provided, containing a first liquid to be dispensed or wherein first containers or container arrangements (3) are provided, containing a first liquid to be dispensed and second containers or container arrangements (4) are provided, containing a second liquid to be dispensed.

13. The receptacle arrangement according to claim 11, comprising a positioning frame (6), wherein at least one receptacle is received in a corresponding recess (61) of the positioning frame (6).

14. A method for assembling a receptacle arrangement according claim 11, comprising the steps of:
providing the frame (1);
arranging at least one container or container arrangement (3;4) in the recesses (11) of the frame (1);
arranging the cover (2) on the frame (1) and thereby enclosing the at least one container or container arrangement (3; 4) between the frame (1) and the cover (2); and
fixing the cover (2) to the frame (1).

15. The method according to claim 14, wherein at least one tear-off film (6) is fixed to the at least one container or container arrangement (3;4) on parts thereof protruding the frame (1), after the at least one container or container arrangement (3;4) have been arranged in the recesses (11) of the frame (1).

16. The receptacle according to claim 1, wherein the fixation of the cover (2) to the frame (1) is reversible.

17. The receptacle according to one of the preceding claims, wherein interlocking elements (150) are provided in the circumferential collar (15) of the frame (1) and at the connectors (14) of the frame (1), wherein interlocking elements (250) are provided in the circumferential collar (25) of the cover (2) and at the crossings of the transverse webs (22; 23) of the cover (2) and the longitudinal webs (24) of the cover (2), and wherein the interlocking elements (150) of the frame (1) matching the corresponding interlocking elements (250) of the cover (2).
